(19) United States
(12) Patent Application Publication
(10) Pub. No.: US 2022/0261886 A1
(43) Pub. Date: Aug. 18, 2022

(54) DEBT MANAGEMENT

(71) Applicant: BRIGHT CAPITAL INC., San Francisco, CA (US)

(72) Inventors: Avinash Raghuveer PATCHAVA, Bangalore (IN); Amit BENDALE, Bangalore (IN); Varun Kumar MODI, Bangalore (IN)

(73) Assignee: BRIGHT CAPITAL INC., San Francisco, CA (US)

(21) Appl. No.: 17/176,508

(22) Filed: Feb. 16, 2021

(51) Int. Cl. G06Q 40/02; G06Q 20/10; G06N 20/00; G06N 5/04

(52) U.S. Cl. CPC G06Q 40/02; G06N 5/04; G06N 20/00; G06Q 20/108

(57) ABSTRACT

In an embodiment, a debt management system (DMS) for managing debt repayments corresponding to debt accounts associated with a user, is disclosed. The DMS is configured to couple with more funds accounts and or more debt accounts associated with the user and obtain financial records and or more debt accounts therefrom, respectively. The DMS further is to predict income in the funds accounts for a predetermined period and predict expenses to be incurred thereto for the predetermined period. The DMS further is to predict a per-day spare amount and calculate a per-day collection amount for each day of the predetermined period. The DMS further is to collect the per-day collection amount from the funds accounts on each day and transfer the per-day collection amount on each day to a collection fund account from which a payment in respect of at least one debt account is made.

### FIELD OF THE INVENTION

The present disclosure relates to debt management. More particularly, the present disclosure relates to automatic management of payment of debt of users.

### BACKGROUND

Consumer Debt is a major part of a country's economy: USA alone has it at ˜$ 14 Tn, of which credit card debt constitutes $ 1 Tn. Debt is an important part of a consumer's financial life and managing its repayment well is of utmost importance to prevent snowballing into it and for financial well-being. A typical consumer can have various types of debts, such as, for example, credit cards, student loan, auto loan, mortgages, etc.

Each debt will be having a minimum viable repayment plan, also referred to as a default plan, laid out by the creditor. Failure to comply with the default plan leads to penalties like late fees, interest rates increase, credit score decrease, balloon payments, etc. Hence, it's very important to adhere to it.

The challenge comes when a consumer has to manage all repayments according to the scheduled plans through his/her own available funds that only get replenished through income. For managing repayments, a consumer needs to assess his/her own cash-flows, keep aside funds for expenses while managing debt, which is complicated, and plans may become hard to comply hence a lot of consumers incur penalties and snowball into debt. Also, almost all of the default plans created by creditors are usually designed to obtain maximum net repayment due to interest accruals every month, and try to keep consumer indebted for a long time. Therefore, a consumer does not have a personalized repayment plan on top of the default plan which would suit his/her cashflows, reduce interest accruals and eventually get out of debt.

Currently, consumer debt is handled through these ways. In a first approach, the consumer manually repaying debt through bank or other payment portals. Consumer manually repaying debt through bank or other portals: This needs constant tracking of budget, control of personal expenses and being vigilant of all the debt plans, which is effort-intensive, compromising on financial lifestyle in some cases and maybe suboptimal since there may not be sufficient funds when consumer wants to pay due to mismanagement, leading to trouble

In a second approach, banks may provide day-triggered autopay options of certain predefined amount. While this is good to keep track of deadlines, it does not do personalized budgeting exercise for user and hence leads to missed payments if funds not available. Also amounts are predefined and not flexible, because this feature is for convenience-only and is not tailored towards getting user debt-free.

In a third approach, some fintech companies provide automatic deductions and then payments towards particular debts. Drawbacks in said approach is that customer has to set payment goal for each debt separately (by looking at own payment plan) and has to do this for every billing period, which is again effort-intensive and hence non-scalable. Furthermore, in some of the existing fintech solutions, there is no guarantee of repayment of the default plans, since it has no knowledge of them, which makes consumer do extra effort on his/her own.

Thus, there is a need for a solution that overcomes the above deficiencies.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

In an embodiment, a debt management system (DMS), implementable in at least one computing device for managing debt repayments corresponding to debt accounts associated with a user, is disclosed. The system includes a processor, a memory, and a communication unit. In an example embodiment, the processor may be coupled to the memory and the communication unit. The DMS further includes an account management engine coupled to the processor. The account management engine is configured to couple with one or more funds accounts associated with the user and obtain one or more financial records corresponding to the one or more funds accounts of the user, each financial record including at least historical transaction data of historic transactions performed using the corresponding funds account. Furthermore, the account management engine is configured to couple with one or more debt accounts of the user and obtain one or more repayment records corresponding to the one or more debt accounts of the user, each repayment record including details associated with repayment of debt related to the corresponding debt account. The DMS further includes a debt management engine coupled to the processor. The debt management engine is configured to predict income in the one or more funds accounts associated with the user for a predetermined period, based on the one or more financial records corresponding to the one or more funds account. The debt management engine is further configured to predict expenses to be incurred to the one or more funds accounts for the predetermined period, based on the one or more financial records corresponding to the one or more funds account. The debt management engine is further configured to predict a per-day spare amount for each day of the predetermined period, based on the predicted income and the predicted expenses. The debt management engine is further configured to calculate a per-day collection amount to be collected from the one or more funds accounts for each day of the predetermined period, based at least on the one or more repayment records and the predicted per-day spare amount for each day. The DMS further includes a payments engine coupled to the processor. The payments engine is configured to collect the calculated per-day collection amount from the one or more funds accounts associated with the user on each of the corresponding day of the predetermined period. Furthermore, the payments engine is configured to transfer the collected per-day collection amount on each of the corresponding day of the predetermined period to a collection fund account. Furthermore, the payments engine is configured to make a payment in respect of at least one debt account of the one or more debt accounts, from the collection fund account.

In another implementation, a method of managing debt repayments corresponding to debt accounts associated with a user is disclosed. The method comprises coupling with one or more funds accounts associated with the user. The method further comprises obtaining one or more financial records corresponding to the one or more funds accounts of the user, each financial record including at least historical transaction data of historical transactions performed using the corresponding funds account. Furthermore, the method comprises coupling with one or more debt accounts of the user. Furthermore, the method comprises obtaining one or more repayment record corresponding to the one or more debt accounts of the user, each repayment record including details associated with repayment of debt related to the corresponding debt account. Furthermore, the method comprises predicting income in the one or more funds accounts associated with the user for a predetermined period, based on the one or more financial records corresponding to the one or more funds account. Furthermore, the method comprises predicting expenses to be incurred to the one or more funds accounts for the predetermined period, based on the one or more financial records corresponding to the one or more funds account. Furthermore, the method comprises predicting a per-day spare amount for each day of the predetermined period, based on the predicted income and the predicted expenses. Furthermore, the method comprises calculating a per-day collection amount to be collected from the one or more funds account for each day of the predetermined period, based at least on the one or more repayment records and the predicted per-day spare amount for each day. Furthermore, the method comprises collecting the calculated per-day collection amount from the one or more funds accounts associated with the user on each of the corresponding day of the predetermined period. Furthermore, the method comprises transferring the collected per-day collection amount on each of the corresponding day of the predetermined period to a collection fund account. Furthermore, the method comprises making a payment in respect of at least one debt account from the one or more debt accounts, from the collection fund account.

In yet another implementation, a non-transitory computer-readable medium comprising computer code for managing debt repayments corresponding to debt accounts associated with a user. The computer code of the computer-readable medium is executable by a machine to perform the above-mentioned method.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a network architecture implementing a debt management system (DMS) for managing debts of users, according to an embodiment of the present subject matter;

FIG. 2 illustrates a schematic block diagram of the DMS for managing debts of users, according to an embodiment of the present subject matter;

FIG. 3 a flowchart of a method 300 for predicting income in a funds account 108, according to an embodiment of the present subject matter;

FIG. 4 illustrates a flowchart of a method for predicting expenses to be incurred to a funds account, according to an embodiment of the present subject matter;

FIG. 5A and FIG. 5B illustrate a flowchart of a method 500 of managing debt repayments corresponding to debt accounts associated with a user, in accordance with an embodiment of the present subject matter; and

FIG. 6 shows an example implementation of the DMS 100 in a computer system 600, in accordance with the embodiment of the present subject matter;

FIG. 7 illustrates an example debt representation, according to an embodiment of the present subject matter.

FIGS. 8-10 illustrate a use case example, in accordance with an example embodiment of the present subject matter

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skilled in the art to which this invention belongs. The system, methods, and examples provided herein are illustrative only and not intended to be limiting.

Embodiments of the present invention will be described below in detail with reference to the accompanying drawings.

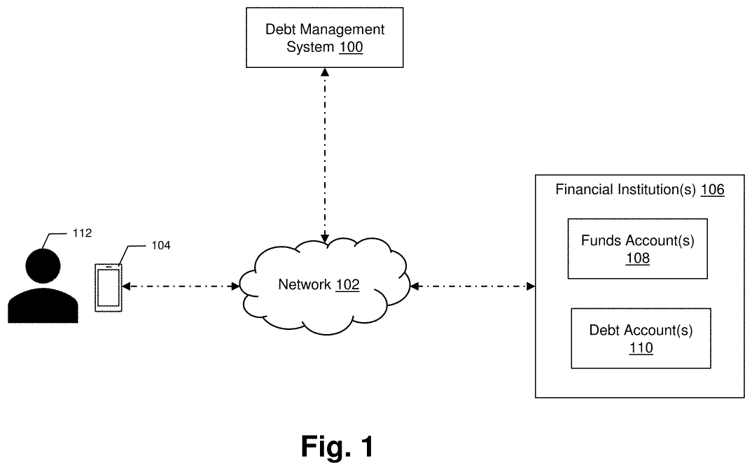

FIG. 1 illustrates a network architecture implementing a debt management system (DMS) 100 for managing debts of users, according to an embodiment of the present subject matter. Examples of the DMS 100 may include, but are not limited to, a server, a remote server, and a cloud server.

In an example, the DMS 100 may be coupled to a network 102 that may be, for example, a Local Area Network (LAN), or the Internet. Accordingly, the DMS 100 may be coupled with and/or communicate with other computing devices, storage devices, etc. through the network 102. The network 102 may be further coupled to a user device 104. Examples of the user device 104 may include, but are not limited to, a tablet, a smartphone, a desktop computer, a laptop, and a Personal Digital Assistant (PDA). In an example, a user 112 may use the user device 104 for availing services from one or more financial institutions 106, such as banks, digital wallets, credit card providers, loan providers, etc.

In an example, the user 112 may hold one or more funds accounts 108 and one or more debt accounts 110, with one or more of these financial institutions 106. Without limitation, examples of the one or more funds accounts 108 may include bank accounts, such as salary accounts, savings accounts, current accounts, savings account acting as salary accounts, etc., associated with the user. The funds account 108 may also include digital wallets associated with the user. Without limitation, the debt accounts 110 may include credit card accounts, home loan account, personal loan account, student loan account, car loan account, personal loan account, electricity connection account, water connection account, gas connection account, mobile phone account, video service subscription account, etc.

According to an example embodiment of the present subject matter, the DMS 100 may be configured to couple with the one or more funds accounts 108 associated with the user 112. After coupling, the DMS 100 may be configured to obtain one or more financial records corresponding to the one or more funds account 108. In an example, each of the one or more financial records may include at least historical transaction data of historic transactions performed using the corresponding funds account. In an example, the financial record may be a bank statement or a digital wallet statement, including credits and debits made from said accounts. In an example, the financial record may be a credit bureau report.

The DMS 100 may be configured to couple with the one or more debt accounts 110 associated with the user 112. After the coupling is successful, the DMS 100 may be configured to obtain one or more repayment records corresponding to the one or more debt accounts 110. In an example, each of the repayment record may include details associated with repayment of debt relating to the corresponding debt account. Without limitation, these details may include a start date of the debt, a target end date of the debt, a rate of interest associated with the debt, a minimum payment amount associated with the debt, a maximum payment amount associated with the debt, an estimated monthly instalment (EMI) associated with the debt, a monetary-benefit policy, a monthly payment due date, etc. The monetary-benefit policy may include details, for example, rewards for advance payment of debts. These rewards, could be in the form of one or more of reduced interest percentage or relaxation in terms of payment period, or improvements in credit score, etc.

The DMS 100 may be further configured to predict income in the one or more funds accounts 108 associated with the user 112 for a predetermined period, based on the corresponding one or more financial records. This predetermined period, in an example, may be fortnight, a month, a quarter, six months, an year, etc. In an example, the predetermined period may be equal to the maximum target end date of all the one or more debt accounts 110. Furthermore, the DMS 100 may be further configured to predict expenses to be incurred to the one or more funds accounts 108 for the predetermined period, based on the one or more financial records corresponding to the one or more funds account 108.

Based on the predicted income and the predicted expenses, the DMS 100 may be configured to predict a per-day spare amount for each day of the predetermined period. Once the per-day spare amount is predicted, the DMS 100 may be configured to calculate a per-day collection amount, based at least on the one or more repayment records corresponding to the one or more debt accounts 110 of the user 112 and the predicted per-day spare amount for each day. In an example, this per-day collection amount is to be collected from the one or more funds accounts 108 for each day of the predetermined period. In an example embodiment, the DMS 100 calculates the per-day collection amount such that the per-day collection amount is less than the per-day spare amount for the corresponding day.

The DMS 100 may be further configured to collect the per-day collection amount from the one or more funds accounts 108 associated with the user 112 on each of the corresponding day of the predetermined period. This collected per-day collection amount may be transferred to a collection fund account, by the DMS 100. Subsequently, the DMS 100 may be configured to make a payment in respect of at least one debt account of the one or more debt accounts 110, from the collection fund account. In an example, the DMS 100 may be configured to identify the monthly payment due date of the at least one debt account, and accordingly make the payment of the EMI for the debt account, or the due amount for the month for the debt account from the collection fund account.

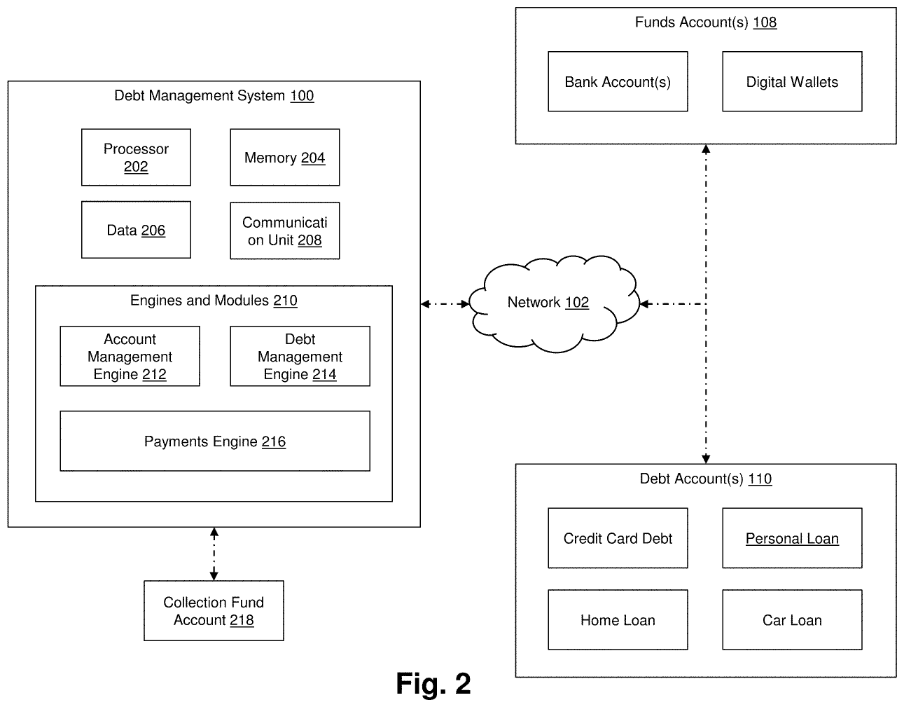

FIG. 2 illustrates a schematic block diagram of the DMS 100 for managing debts of users, according to an embodiment of the present subject matter. In an example, the DMS 100 may be implemented in computing devices, such as a server, a remote server, a cloud server, etc. Furthermore, the DMS 100 may be implemented either in a single device or in a distributed manner in a plurality of device, the implementation of which would be apparent to a person skilled in the art. In an example embodiment, the DMS 100 may include at least one processor 202, memory 204, data 206, at least one communication unit 208, and engines and modules 210.

In an example, the processor 202 may be a single processing unit or a number of units, all of which could include multiple computing units. The processor 202 may be implemented as one or more microprocessors, microcomputers, microcontrollers, digital signal processors, central processing units, state machines, logic circuitries, an application processor (AP), or the like, a graphics-only processing unit such as a graphics processing unit (GPU), a visual processing unit (VPU), and/or an AI-dedicated processor such as a neural processing unit (NPU), and/or any devices that manipulate signals based on operational instructions. Among other capabilities, the processor 202 is configured to fetch and execute computer-readable instructions and data stored in the memory 204.

The memory 204 may include any non-transitory computer-readable medium known in the art including, for example, volatile memory, such as static random access memory (SRAM) and dynamic random access memory (DRAM), and/or non-volatile memory, such as read-only memory (ROM), erasable programmable ROM, flash memories, hard disks, optical disks, and magnetic tapes.

The data 206 serves, amongst other things, as a repository for storing data processed, received, and generated by one or more of the processor 202. Writing further, in a non-limiting manner, one or more of the aforementioned components of the DMS 100 may send or receive data, for example, using one or more input/output ports and one or more communication units.

In an example, the communication unit 208 may include one or more hardware units that support wired or wireless communication between the DMS 100 and any other computing devices.

The engines and module(s) 210, amongst other things, may include routines, programs, objects, components, data structures, etc., which perform particular tasks or implement data types. The engines and module(s) 210 may also be implemented as, signal processor(s), state machine(s), logic circuitries, and/or any other device or component that manipulate signals based on operational instructions.

Further, the engines and module(s) 210 may be implemented in hardware, instructions executed by at least one processing unit, for e.g., processor 202, or by a combination thereof. The processing unit may be a general-purpose processor which executes instructions to cause the general-purpose processor to perform operations or, the processing unit may be dedicated to performing the required functions. In another aspect of the present disclosure, the engines and module(s) 210 may be machine-readable instructions (software) which, when executed by a processor/processing unit, may perform any of the described functionalities.

In some example embodiments, the engines and module(s) 210 may be machine-readable instructions (software) which, when executed by a processor/processing unit, perform any of the described functionalities.

In an example, the engines and module(s) 210 may include an account management engine 212, a debt management engine 214, and a payments engine 216. In an example, the processor 202 may be coupled to the engines and module(s) 210 for performing one or more operations, as described herein.

Furthermore, in an example embodiment, at least one of the plurality of engines and module(s) 210 may be implemented through an AI model. In said example embodiment, the processor 202 may provide input data to the AI model and accordingly obtain inference data from the AI model. Herein, the AI model may be a trained neural network model. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks. According to an intended aim/goal of the AI model, the AI model may accordingly be trained using learning algorithms and training data during the training phase. Examples of learning algorithms include, but are not limited to, supervised learning, unsupervised learning, semi-supervised learning, or reinforcement learning.

As described herein, the DMS 100 may be configured to manage debt related payments for users, such as user 112. To that end, in an example embodiment, the account management engine 212 may be configured to couple with the one or more funds accounts 108 of the user 112. As is shown in the figure, without limitation, the one or more funds account 108 may include bank accounts and digital wallets associated with the user 112. In an example, the account management engine 212 may be configured to couple with the funds accounts 108 through a bank aggregator. In an example, the term “coupling” may include one or more of, granting of necessary permissions, authorizations, authentications, establishing of a communication session, between the DMS 100 and the funds accounts 108. Upon successful coupling, the account management engine 212 may be configured to obtain a financial record corresponding to each of the funds accounts 108. In an example, the account management engine 212 may make a request to the bank aggregator and accordingly may receive the financial record as aggregator data from a server of the bank aggregator. In an example, the account management engine 212 may be configured to store the financial record in the data 206.

Furthermore, in an example embodiment, the account management engine 212 may be configured to provide the user with an option to set a fund threshold corresponding to each of the one or more funds accounts 108 associated with the user 112. The fund threshold may be understood as a minimum amount that must be maintained in a given funds account 108. Accordingly, withdrawals from the funds account 108 may be made, as per the fund threshold. In an example, the accounts management engine 212 may provide the option through an application interface of an application running on the user device 104. As would be understood, the user may have installed the application that is linked to the DMS 100, and said application provides for various interfaces and options for performing the operations and functions as described herein, including registration of the user with the DMS 100 for availing debt management services. On providing with the options, the account management engine 212 may receive a user selection for setting the fund threshold of at least one funds account from the one or more funds account 108. Accordingly, the account management engine 212 may provide a corresponding field on the display for the user to enter the fund threshold amount. The amount entered by the user is then set as the fund threshold for the funds account, by the account management engine 212.

The account management engine 212 may be further configured to couple with the one or more debt accounts 110 of the user 112. As shown in the figure, without limitation, the one or more debt accounts 110 may include credit card debt accounts, personal loan accounts, home loan accounts, car loan accounts, etc., associated with the user 112. In an example, the account management engine 212 may be configured to couple with the debt accounts 110 through a bank aggregator. In an example, the term “coupling” may include one or more of, granting of necessary permissions, authorizations, authentications, establishing of a communication session, between the DMS 100 and the debt accounts 110.

Upon successful coupling, the account management engine 212 may be configured to obtain a repayment record corresponding to each of the debt accounts 110. In an example, the account management engine 212 may make a request to the bank aggregator or a credit bureau for the repayment record and accordingly may receive the repayment record as aggregator data from the server of the bank aggregator or the credit bureau. In an example, the account management engine 212 may be configured to store the repayment records corresponding to the debt accounts 110 in the data 206.

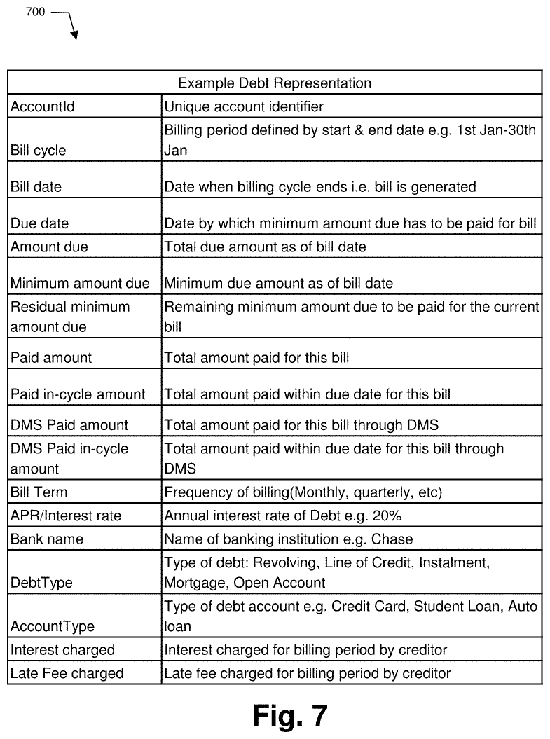

As may be understood, the different debt accounts may have different forms of representation of debts. In other words, the details of the debts may be represented in different forms. Thus, in an example, the account management engine 212 may be further configured to store the details of all the debts of the user 112 in a predefined standard format. To that end, the account management engine 212 may be configured to identify, for each of the one or more debt accounts 110, the details associated with repayment of the debt from the corresponding repayment record. Once the details are identified, the account management engine 212 may be configured to generate a unified repayment record for the debt based on the identified details. The unified repayment record may include the identified details of the debt in a default representation format, for example, such as the example debt representation 700 shown in FIG. 7. As shown, the example debt representation may include several fields, such as Account identity, Bill cycle, bill date, due date, amount date, minimum amount due, and residual minimum amount due. The fields may further include paid amount, paid in-cycle amount, DMS paid amount, DMS paid in-cycle amount, bill term, APR/interest rate, bank name, debt type, account type, interest charged, and late fee charged. The account management engine 212 may further store the generated unified repayment record in the data 206.

In an example, a repayment record corresponding to a debt may include some missing details. For instance, the repayment record may not include details of the minimum due amount. Accordingly, in an example embodiment, the account management engine 212 may be configured to detect a missing detail in the corresponding repayment record of the debt. Subsequently, the account management engine 212 may be configured to infer an input corresponding to the missing detail based on the one or more financial records and/or the one or more repayment records. Once the missing detail is inferred, the account management engine 212 may be configured to include the inferred input corresponding to the missing detail in the unified payment record for the debt.

As an example, consider a case where a bill date for a credit card debt is missing. In said example, the account management engine 212 may identify the latest interest charge transaction date on credit card. Typically, the bank charges interest on bill date. Accordingly, the account management engine 212 may select the latest interest charge transaction date as the bill date. In another example, if the due date is available, the account management engine 212 uses the due date minus the bank level grace period as the bill date.

In another example, where due date is missing, the account management engine 212 may be configured to identify if aggregator gave any due date. Accordingly, the account management engine 212 may be configured to extract the day of the month and pull to the current month. As is known, the due date remains the same every month. Thus, the account management engine 212 may use the aggregator given due date as the due date for the month. In another example, if the bill date is available, the account management engine 212 may be configured to add the grace period to bill date to infer the due date.

In yet another example, where the minimum due amount detail is missing, the account management engine 212 may be configured to use a rule-based approach for determining the minimum due amount. In said rule, the account management engine 212 at first may identify the outstanding amount. In a case where the outstanding amount is not available, the account management engine 212 may be configured to use the last known balance of credit card as the outstanding amount. Thereafter, the account management engine 212 may be configured to identify a percentage used by the corresponding bank as minimum amount due percentage. Subsequently, the account management engine 212 may also check for applicability of interest charges. Accordingly, the account management engine 212 uses the following rule:

Minimum amount due=x% of the outstanding amount+interest charges

where x=percentage defined by the bank

In case the interest charges are not available, the account management engine 212 may be configured to use the following formula for calculating the interest charges:

ADB*(APR/365)*30 days

where ADB=average daily credit card balance in billing cycle of month and APR=annual interest rate

In yet another example, where the outstanding amount is missing, the account management engine 212 may be configured to use the balance on or near to the bill date of credit card from aggregator as the outstanding amount. If nearby balance is not available from aggregator, the account management engine 212 may be configured to replay balance from current time till bill date using transactions to get the outstanding amount.

In yet another example, where the annual interest rate, interchangeably referred to as APR in abbreviated form, is missing, the account management engine 212 may be configured to find the interest charges through transactions using the below formula.

APR=ADB*(APR/365)*30

In an example embodiment, the account management engine 212 may implement one or more AI models for inferring the missing details. As an example, a Logistic regression model may be implemented for drawing the inferences for the missing fields. In an example, the AI model may be trained using data, such as, but not limited to, the repayment records, the financial records, and the above-mentioned formulae, or any other formula as appropriate for a given missing field. In an example, the one or more AI models may produce estimates for all elements of billing cycle, if data is not available through direct mechanism of aggregator/credit report/user feedback. Accordingly, the AI model may implement, rule-based calculative systems at bank level and implementation of time-series modelling techniques.

In another example embodiment, the account management engine 212 may be configured to obtain the missing detail or correct an already included detail, based on a user input. To that end, the account management engine 212 may display the unified repayment record on a display of the user device 104, along with options to edit the details captured therein. Accordingly, in case the user wishes to modify a detail, the user may provide the user input and the account management engine 212 may update the corresponding detail accordingly.

In another example, user requests may be received from the user device 104 via a web request portal or an application interface of an application running on the user device 104. These requests, in an example, may be stored in the data 206. In such a case, the account management engine 212 may search for requests relating to the user 112's requests for modifying details of the unified repayment record of any debt. If found, the account management engine 212 may be configured to process the request and update the unified payment record for the debt accordingly.

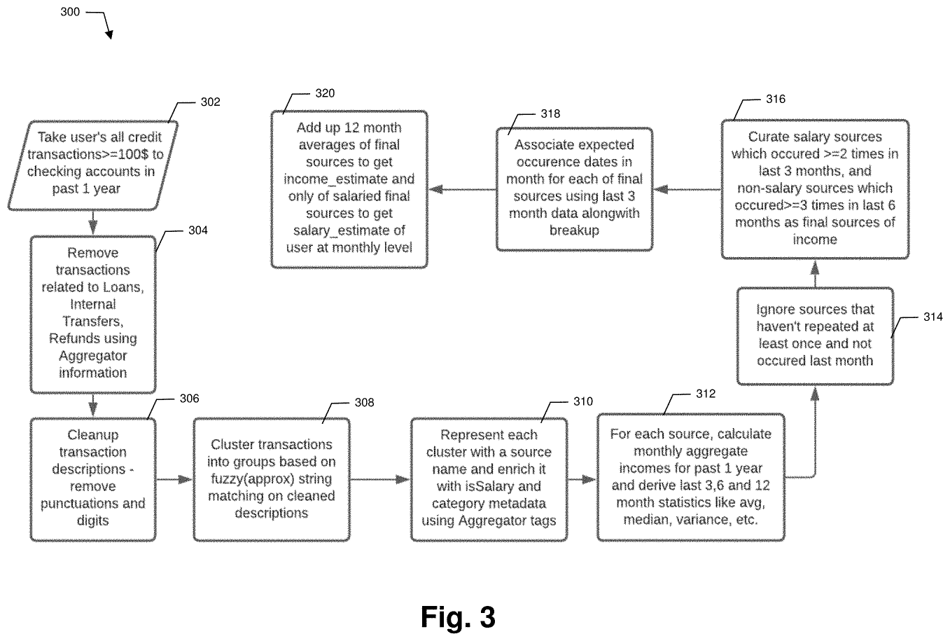

In an example embodiment, the debt management engine 214 may be configured to predict income in the one or more funds accounts 108 associated with the user 112 for a predetermined period, based on the one or more financial records corresponding to the one or more funds account 108. In an example, the debt management engine 214 may perform the method as illustrated in FIG. 3 for predicting the income.

Referring to FIG. 3, a flowchart of a method 300 for predicting income in a funds account 108, according to an embodiment of the present subject matter is illustrated. As would be understood, the illustrated method 300 is for calculating the income prediction account for one funds account and the method 300 may be performed separately for each of the funds account 108 of the user 112. In case the user 112 has more than one funds account 108, the final income prediction may be done by summing up the income predictions for the different funds account 108.

As shown, at step 302, the debt management engine 214 may be configured to take user's all credit transactions that are greater than a threshold amount in the funds account 108. In an example, the threshold amount may be USD 100.

At step 304, the debt management engine 214 may be configured to remove transactions related to loans, internal transfers, and refunds, using aggregator information. Thereafter, at step 306, the debt management engine 214 may be configured to clean up transaction descriptions. For example, all punctuation and/or digits may be removed.

Subsequently, at step 308, the debt management engine 214 may be configured to cluster transactions into groups based on fuzzy (approx.) string matching on cleansed descriptions. Thereafter, at step 310, the debt management engine 214 may be configured to represent each cluster with a source name and enrich it with “issalary” and category metadata using aggregator tags. Now at step, 312, for each source, the debt management engine 214 may be configured to calculate monthly aggregate income for past 1 year and derive last 3, 6, and 12 months, statistics. These statistics may include, without limitation, average, median, variance, etc.

At step 314, the debt management engine 214 may be configured to ignore sources which did not repeat at least once and/or not occurred in the last one month. At step 316, the debt management engine 214 may be configured to curate salary sources that occurred equal to or more than two times in the past 3 months. Furthermore, the dent management engine 214 may also curate non-salary sources that occurred equal to or more than 3 times in the last 6 months. These curated salary sources and non-salary source are selected as final sources of income, by the debt management engine 214.

At step 318, the debt management engine 214 may be configured to associate expected occurrence dates in month for each of the final sources of income based on last 3 months data, along with breakup. At step 320, the debt management engine 214 may be configured to add up 12-month averages of final sources of income to predict the income. Furthermore, the debt management engine 212 may be configured to also predict the salary collection based on 12-month averages of the curated salary sources. This, as would be understood, is a part of the predicted income.

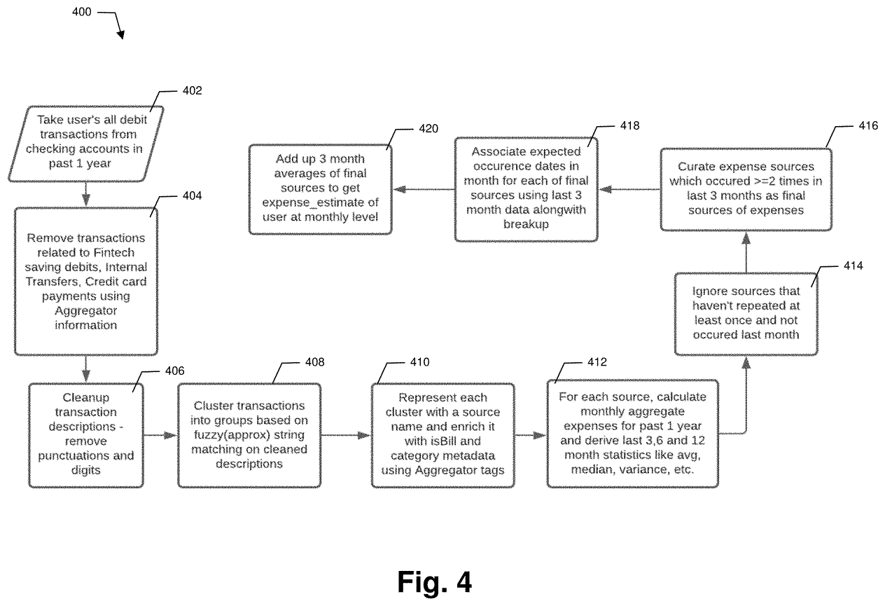

In an example embodiment, the debt management engine 214 may be configured to predict expenses to be incurred to the one or more funds accounts 108 for the predetermined period, based on the one or more financial records corresponding to the one or more funds account 108. In an example, the debt management engine 214 may perform the method as illustrated in FIG. 4 for predicting the expense to be incurred to the one or more funds account 108.

Referring to FIG. 4, a flowchart of a method 400 for predicting expenses to be incurred to a funds account 108, according to an embodiment of the present subject matter is illustrated. As would be understood, the illustrated method 400 is for calculating the expenses to be incurred to one funds account 108 and the method 400 may be performed separately for each of the funds account 108 of the user 112, to predict the expenses to be incurred thereto. In case the user 112 has more than one funds account 108, the final expenses prediction may be done by summing up the expense predictions for the different funds account 108.

At step 402, the debt management engine 214 may be configured to identify user 112's all debit transactions that have been made from the funds account 108 in the last one year. At step 404, the debt management engine 214 may be configured to learn and remove transactions relating to fintech saving debits, internal transfers, credit card payments, based on the aggregator information. The fintech saving debits may be understood as debits may by other debt management platforms.

At step 406, the debt management engine 214 may be configured to clean up transaction descriptions. For example, all punctuation and/or digits may be removed. Subsequently, at step 408, the debt management engine 214 may be configured to cluster transactions into groups based on fuzzy (approx.) string matching on cleansed descriptions. Thereafter, at step 410, the debt management engine 214 may be configured to represent each cluster with a source name and enrich it with “isBill” and category metadata using aggregator tags. Now at step, 412, for each source, the debt management engine 214 may be configured to calculate monthly aggregate income for past 1 year and derive last 3, 6, and 12 months, statistics. These statistics may include, without limitation, average, median, variance, etc.

At step 414, the debt management engine 214 may be configured to ignore sources that have not repeated at least once and not occurred in the last month. At step 416, the debt management engine 214 may be configured to curate expense sources that occurred equal to or more than two times in the last three months, as final sources of expenses.

At step 416, the debt management engine 214 may be configured to associated expected occurrence dates in month for each of the final sources of expenses, based on last 3 months data with breakup. At step 418, the debt management engine 214 may be configured to add up 3 month averages of final sources of expenses to get the predicted expenses for the funds account 108 at monthly level.

Thus, as explained above, the debt management engine 214 predicts the income and predicts the expenses for the predetermined period. In an example embodiment, the debt management engine 214 may be configured to implement one or more AI models for performing one or more of identification of sources, estimation of date ranges, and estimation of amounts of expected incomes in funding accounts 108 of the user 112 in current month through use of time-series modeling and Natural Language Processing (NLP) techniques. Furthermore, the debt management engine 214 may also use the one or more AI models for estimating amounts of expected spends out of funding accounts 108 of the user 112 in current month through use of time-series modeling and NLP. In an example, for the above predictions, the AI models may be trained using training data that includes the financial records corresponding to the funds accounts of the user. As described herein, these financial records may include details of the debits and credits. In an example and without limitation, the debits and credits of past one year may be analyzed for making the predictions. In an example, during the training and during the implementation, credits such as loan credits, internal account transfers, digital wallet credits, refunds, reversals, may be excluded when determining the income. Similarly, internal account transfers, digital wallet debits, and overdraft fees and other penalties, may be excluded from debits, when predicting the expenses. In an example, models, such as fuzzy clustering may be used for identification of source and a seasonal autoregressive integrated moving average (SARIMA) model may be used for time series prediction of each source.

Upon predicting the income and predicting the expenses, the debt management engine 214 may be configured to predict a per-day spare amount for each day of the predetermined period, based on the predicted income and the predicted expenses. For predicting the per-day spare amount, the debt management engine 214 may remove already occurred incomes and expenses in the course of month from the predicted instances by looking at the transactions performed for that month. Furthermore, the debt management engine 214 also maintains a list of upcoming incomes and expenses. In an example, the debt management engine 214 may sort the list of upcoming incomes and expenses using the median date of occurrence.

In an example, in addition to the regular expenses identified above, the debt management engine 214 may take last 3-month average of non-regular expenses and pro-rate them till end of month. Accordingly, the debt management engine 214 projects the balance from current day till next 1 month for every day using upcoming incomes, expenses and pro-rated irregular expenses. Thus, in an example, the debt management engine 214 predicts the spare amount as the minimum projected daily balance over next 1 month leaving aside user's settings of funds threshold. In an example, the debt management engine 214 may implement the below formula for predicting the per-day saving amount.
Assume current balance=B,
sorted upcoming income and expense list merged according to timeline L={(dj, Ij, Ej)} where j is day from 1(tomorrow) till 30(Assume I0=E0=0 and balance is updated on end of today).
Assume F=balance floor setting and IR=irregular daily average expense. Then, per-day spare amount (A):

A=min_{k=1..30}(Σ^{j=k}ⱼ₌₁(B+Iⱼ−Eⱼ−j*IR))−F

The debt management engine 214 may be further configured to calculate a per-day collection amount to be collected from the one or more funds accounts 108 for each day of the predetermined period, based at least on the one or more repayment records and the predicted per-day spare amount for each day. In an embodiment, besides the aforementioned, the per-day collection amount may be further calculated based on goal amount. The goal amount may be understood as monthly budget amount that is set by user for payments of debts. In an example, the debt management engine 214 may provide the user with an option to set the goal amount through a user interface displayed on the display of the user device 104.

In an example, the debt management engine 214 implements a run-rate based mechanism for calculating the per-day collection amount. In other words, the run-rate based mechanism helps in collecting regular amounts to meet due dates (deadlines) in a normalized smooth manner. On days with high affordability, the collection can be shot up by 2×. In an example, the debt management engine 214 may be configured to collect only when a positive collection is possible (post all calculations and constraints).

The following example description is based on debt payments being made from a single funds account. As may be understood any of: one-to-one or one-to-many or many-to-many model of facilitating payments from funds accounts 108 may be implemented. In an example, the debt management engine 214 may implement the following formulae for calculating the per-day collection amount:

### Assume:

G=monthly goal set by user, which is budget set for debt payments
F=funds threshold for the funds account set by user (no collection if balance is <=F)
B=today's funds account balance for the highest balance account
C1, C2, . . . Cn are credit cards/debt accounts in subscription
M1, M2, . . . Mn are statement minimum dues of credit cards/debt accounts in subscription
DD1, DD2, . . . DDn are due dates of respective cards/debts
Let pd=payment delay between submission and reconciliation by bank=3 days
rG=remaining goal of user for month (subtract collections till now of month from G, since they fill up the goal)
rSG=remaining surplus goal of user for month (surplus=extra paydown above mindue)
rM1, rM2, . . . rMn are reduced minimum due of credit cards/debts in subscription
uP1, uP2, . . . uPn are user payments towards credit cards/debts in order
bCol=Collections till current date from start of month for user
bP1, bP2, . . . bPn are DMS payments towards credit cards/debts in order in this month
rD1, rD2, . . . rDn=remaining days till due date of cards/debts from current date
rEom=remaining days till end of month
mindue_rr: mindue runrate, surplus_rr: surplus runrate, abs_esc_mindue_rr: absolute escalated mindue runrate, simple_escalated_mindue_rr: simple escalated mindue runrate, goal_rr: goal run rate
Let per-day collection amount be A
Let highest collection amount in last 30 days for user be H
Let today's collection amount be CA

### Residual Calculations:

rG=G−bCol

rSG=min(G−ΣMᵢ,rG)

rMᵢ=max(0, Mᵢ−bPᵢ−uPᵢ)

rDᵢ=DDᵢ−today−p_{d}

### Run-Rate Calculations:

mindueᵣᵣ=Σ(rMᵢ/rDi)

surplusᵣᵣ=(rSG/(rEom−p_{d}))

absEscMindueᵣᵣ=Σ(rMᵢ) for i whose due date is very near(within 5 days)

simpleEscMindueᵣᵣ=Σ(rMᵢ) for i whose due date is very near+Σ(rMᵢ/rDi) for i whose due date is not near

goalᵣᵣ=(rG/(rEom−p_{d}))

### Per-day Collection Amount Calculation

CA=max(mindueᵣᵣ,surplusᵣᵣ,absEscMindueᵣᵣ,simpleEscMindueᵣᵣ, goalᵣᵣ) . . . [Best collection to satisfy all requirements]
CA=2*CA if A>2*CA . . . [Double collection when highly affordable to user]
CA=min(CA, 30%B) . . . [Prevention of overdrafts for user]
CA=min(CA, B−F) . . . [Honor user setting of floor value]
CA=min(CA,1.5*H) . . . [Prevent shock to user due to sudden big collection, i.e., spike capping]

In an example, the debt management engine 214 may be configured to calculate the per-day collection amount such that the calculated per-day collection amount for each day is equal to one of: at least a portion of the corresponding per-day spare amount for the day and the corresponding per-day spare amount for the day.

In an example embodiment, the debt management engine 214 may be configured to obtain the repayment record corresponding to each of the one or more debt accounts 110 of the user. Subsequently, the debt management engine 214 may be configured to identify at least one debt account 110 from the one or more debt accounts 110 having a monetary-benefit policy associated therewith, based on the corresponding repayment record. Accordingly, upon identifying such a debt account 110, the debt management engine 214 may be configured to predict the per-day collection amount of at least one day in the predetermined period based on the monetary-benefit policy. In other words, the debt management engine 214 may calculate the per-day collection amount such that advance payment of the debt account 110 can be made. This allows for leveraging the benefit of rewards offered by the monetary-benefit policy.

As is known, the user may make non-predicted transactions as well. Accordingly, in an example embodiment, the account management engine 212 may be configured to detect a non-predicted transaction in at least one funds account 110 of the one or more funds account 110. Accordingly, the debt management engine 214 may be configured to update the predicted expenses, the predicted per-day spare amount, and the calculated per-day collection amount, as per the formulae and techniques described above.

In yet another example, the debt management engine 214 may be configured to provide the user with the ability to set and/or edit the per-day collection amount. To that end, the debt management engine 214 may be configured to display the calculated per-day collection amount for each day of the predetermined period to the user using a display interface. In response, the debt management engine 214, may be configured to receive a user input for updating the calculated per-day collection amount for at least one day in the predetermined period. Herein, the user input may be understood as an input defining a new collection amount. Furthermore, the debt management engine 214 may be configured to update the per-day collection amount for the at least one day based on the received user input. That is, the new collection amount is included as the per-day collection amount for the day.

In an example, the debt management engine 214 may be configured to store data including the predicted per-day spare amount details and the calculated per-day collection amount details in the data 206.

In an example embodiment, the payments engine 216 may be configured to collect the calculated per-day collection amount from the one or more funds accounts 108 associated with the user on each of the corresponding day of the predetermined period. As mentioned herein, the DMS 100 is authorized during the coupling thereof with the funds accounts 108. Accordingly, the payments engine 216 may collect the per-day collection amount every day from the funds account 108. When collecting the per-day collection amount, the payments engine 216 may be configured to collect the calculated per-day collection amount from the one or more funds accounts 108, based on the fund threshold corresponding to the one or more funds accounts 108. That is, in case a funds threshold has been set by the user, the payments engine 216 performs a check prior to collection of the per-day collection amount as to whether the per-day collection amount is less than the fund account or not. If the per-day collection amount is determined to be less, the payments engine 216 may be configured to then proceed with the collection of the per-day collection amount.

In an example embodiment, the payments engine 216 may be configured to transfer the collected per-day collection amount on each of the corresponding day of the predetermined period to a collection fund account 218. In an example, the collection fund account may be a bank account or a digital wallet.

In an example embodiment, the payments engine 216 may be configured to make a payment in respect of at least one debt account 110 of the one or more debt accounts 110, from the collection fund account 218.

For making the payments in respect of one or more debt accounts 110, in an example, the payments engine 216 may be configured to perform sorting of the debt accounts based on the due dates. Subsequently, the payments engine 216 may be configured to prioritize payments as per remaining minimum dues of the sorted debt accounts 110. Any spillover may be transferred to the next debt account 110.

In an example, any extra balance if left is subsequently allocated to a debt account 110 having the highest corresponding interest, by the payments engine 216. In an example, the surplus is scheduled on current_day+5 days by the payments engine 216, only when all rMis are zero. This can occur when either all debt accounts are out of billing cycles or all rMis have been paid off In other words, it is done when no priority liabilities need to be catered to.

In an example, if rM1 can be completely filled, it is scheduled on current_day+5 days i.e., advance scheduling before due date, by the payments engine 216. In another case, if rM1 cannot be completely filled, it is scheduled on DD1−p_d, by the payments engine 216. In other words, till last cutoff day before due date when the payment can be made to reach debt account 110 on due date. This is done in the hope that if more funds come along, the schedule need not be changed.

Thus, the payments engine 216 may be configured to allocate the money for payments as described above. In an example, based on changes in the account, for example, in case more money becomes available, a future-scheduled partial mindue payment may be pulled back to make advance full payment on current_day+5 days according to rule mentioned earlier. Thus, a dynamic allocation and payment mechanism is implemented, whereby the payments engine 216 may be configured to monitor the previously scheduled payments, and update them according to latest allocation. This allocation and payments data is stored in the data 206. Thus, accordingly, the payments engine 216 may make the payments towards one or more or all of the debt accounts 110.

In an example, the user may seek to transfer back some or all of the money in the collection fund account 218 to one or more funds accounts 108. In such a case, the payments engine 216 may be configured to receive a user request to transfer a portion of the collection amount present in the collection fund account 218 to at least one funds account 108 from the one or more funds account 108 of the user 112. Accordingly, the payments engine 216 may be configured to transfer the portion of the collection amount to the at least one funds account 108.

Furthermore, in said embodiment, the debt management engine 214 may be configured to update the predicted income, the predicted per-day spare amount, and the calculated per-day collection amount according to the formulae and techniques described herein.

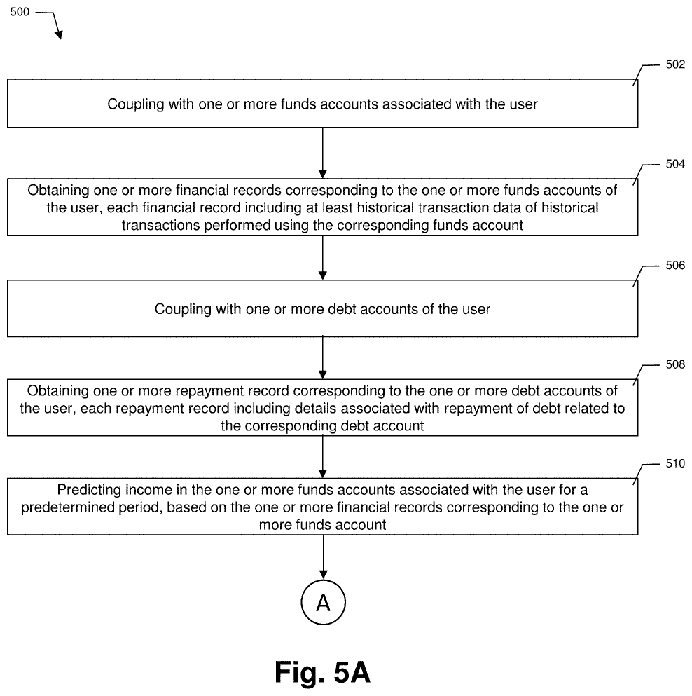

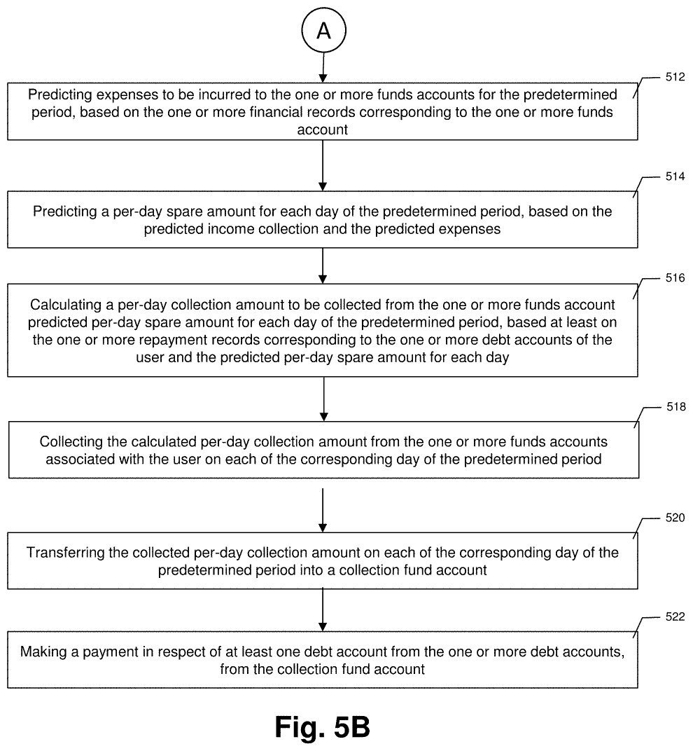

FIG. 5A and FIG. 5B illustrate a flowchart of a method 500 of managing debt repayments corresponding to debt accounts associated with a user, in accordance with an embodiment of the present subject matter. The method 100 may be implemented in computing nodes, such as, but not limited to, a server, a desktop computer, a smartphone, a workstation computer, and a laptop.

At step 502, the method 500 includes coupling with one or more funds accounts associated with the user. At step 504, the method 500 includes obtaining one or more financial records corresponding to the one or more funds accounts of the user, each financial record including at least historical transaction data of historical transactions performed using the corresponding funds account.

At step 506, the method 500 includes coupling with one or more debt accounts of the user. At step 508, the method 500 includes obtaining one or more repayment record corresponding to the one or more debt accounts of the user, each repayment record including details associated with repayment of debt related to the corresponding debt account

At step 510, the method 500 includes predicting income in the one or more funds accounts associated with the user for a predetermined period, based on the one or more financial records corresponding to the one or more funds account.

At step 512, the method 500 includes predicting expenses to be incurred to the one or more funds accounts for the predetermined period, based on the one or more financial records corresponding to the one or more funds account.

At step 514, the method 500 includes predicting a per-day spare amount for each day of the predetermined period, based on the predicted income and the predicted expenses. At step 516, the method 500 includes calculating a per-day collection amount to be collected from the one or more funds account for each day of the predetermined period, based at least on the one or more repayment records and the predicted per-day spare amount for each day. In an example, the calculated per-day collection amount for each day is equal to one of: at least a portion of the corresponding per-day spare amount for the day and the corresponding per-day spare amount for the day.

At step 518, the method 500 includes collecting the calculated per-day collection amount from the one or more funds accounts associated with the user on each of the corresponding day of the predetermined period. At step 520, the method 500 includes transferring the collected per-day collection amount on each of the corresponding day of the predetermined period to a collection fund account. At step 522, the method 500 includes making a payment in respect of at least one debt account from the one or more debt accounts, from the collection fund account.

In some embodiments, the method 500 includes providing the user with an option to set a fund threshold corresponding to each of the one or more funds accounts associated with the user. Furthermore, the method 500 includes receiving a user selection for setting the fund threshold of at least one funds account from the one or more funds account. Furthermore, the method 500 includes collecting the calculated per-day collection amount from the one or more funds accounts, based on the fund threshold corresponding to the one or more funds accounts.

In some embodiments, the method 500 includes identifying, for each of the one or more debt accounts, the details associated with repayment of the debt from the corresponding repayment record. The method 500 further includes generating a unified repayment record for the debt based on the identified details, wherein the unified repayment record includes the identified details in a default representation format. The method 500 further includes storing the unified repayment record for the debt in a storage.

In some embodiments, the method 500 includes detecting a missing detail in the corresponding repayment record of the debt. The method 500 further includes inferring an input corresponding to the missing detail based on one or more of: the one or more financial records and the one or more repayment records. Furthermore, the method 500 includes including the inferred input corresponding to the missing detail in the unified payment record for the debt.

In some embodiments, the method 500 includes detecting a non-predicted transaction in at least one funds account of the one or more funds account. Furthermore, the method 500 includes updating the predicted expenses. Furthermore, the method 500 includes updating the predicted per-day spare amount. Furthermore, the method 500 includes updating the calculated per-day collection amount.

In some embodiments, the method 500 includes obtaining the repayment record corresponding to each of the one or more debt accounts of the user. The method 500 further includes identifying at least one debt account from the one or more debt accounts having a monetary-benefit policy associated therewith, based on the corresponding repayment record. Furthermore, the method 500 includes predicting the per-day collection amount of at least one day in the predetermined period based on the monetary-benefit policy.

In some embodiments, the method 500 includes displaying the calculated per-day collection amount for each day of the predetermined period to the user using a display interface. Furthermore, the method 500 includes receiving a user input for updating the calculated per-day collection amount for at least one day in the predetermined period, the user input defining a new collection amount. Furthermore, the method 500 includes updating the per-day collection amount for the one day based on the received user input.

In some embodiments, the method 500 includes receiving a user request to transfer a portion of the collection amount present in the collection fund account to at least one funds account from the one or more funds account of the user. Furthermore, the method 500 includes transferring the portion of the collection amount to the at least one funds account. Furthermore, the method 500 includes updating the predicted income. Furthermore, the method 500 includes updating the predicted per-day spare amount. Furthermore, the method 500 includes updating the calculated per-day collection amount.

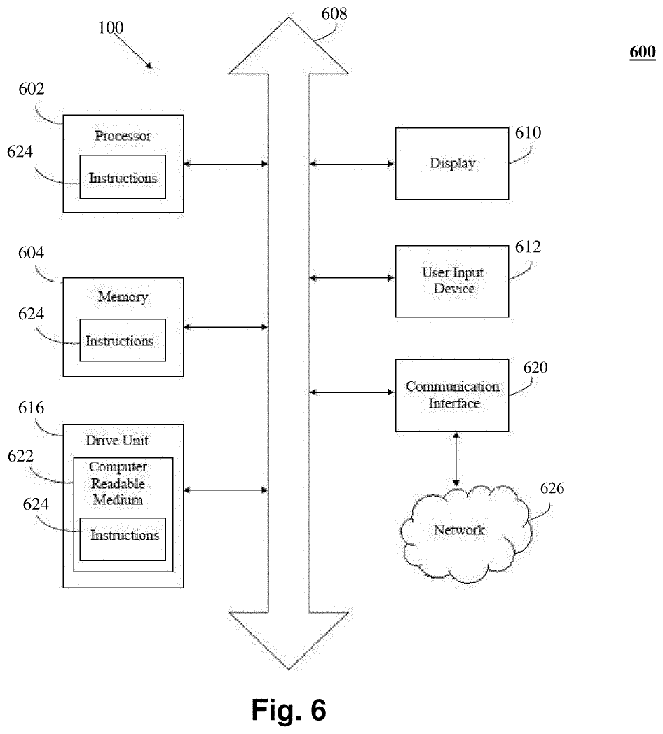

FIG. 6 shows an example implementation of the DMS 100 in a computer system 600, in accordance with the embodiment of the present subject matter. The computer system 600 can include a set of instructions that can be executed to cause the computer system 600 to perform any one or more of the methods disclosed. The computer system 600 may operate as a standalone device or may be connected, e.g., using a network, to other computer systems or peripheral devices.

In a networked deployment, the computer system 600 can be implemented as or incorporated across various devices, such as a tablet PC, a personal digital assistant (PDA), a mobile-device, a palmtop computer, a laptop computer, a desktop computer, a server, a cloud server, a remote server, a communications device, or any other machine controllable through a wireless-network and capable of executing a set of instructions (sequential or otherwise) that specify actions to be taken by that machine. Further, while a single computer system 600 is illustrated, the term “system” shall also be taken to include any collection of systems or sub-systems that individually or jointly execute a set, or multiple-sets, of instructions to perform one or more computer functions.

The computer system 600 may include a processor 602 e.g., a central processing unit (CPU), a graphics processing unit (GPU), or both. The processor 602 may be a component in a variety of systems. For example, the processor 602 may be part of a standard personal computer or a workstation. The processor 602 may be one or more general processors, digital signal processors, application specific integrated circuits, field programmable gate arrays, servers, networks, digital circuits, analog circuits, combinations thereof, or other now known or later developed devices for analyzing and processing data. The processor 602 may implement a software program, such as code generated manually (i.e., programmed).

The computer system 600 may include a memory 604, such as a memory 604 that can communicate via a bus 608. The memory 604 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, optical media and the like. In one example, the memory 604 includes a cache or random access memory for the processor 602. In alternative examples, the memory 604 is separate from the processor 602, such as a cache memory of a processor, the system memory, or other memory. The memory 604 may be an external storage device or database for storing data. The memory 604 is operable to store instructions executable by the processor 602. The functions, acts or tasks illustrated in the figures or described may be performed by the programmed processor 602 executing the instructions stored in the memory 604. The functions, acts or tasks are independent of the particular type of instructions set, storage media, processor or processing strategy and may be performed by software, hardware, integrated circuits, firmware, micro-code and the like, operating alone or in combination. Likewise, processing strategies may include multiprocessing, multitasking, parallel processing and the like.

As shown, the computer system 600 may or may not further include a touch-sensitive display unit 610, for outputting determined information as well as receiving a user's touch-gesture based inputs, such as drag and drop, single tap, multiple-taps, etc. The display 610 may act as an interface for the user to see the functioning of the processor 602, or specifically as an interface with the software stored in the memory 604 or in the drive unit 616.

Additionally, the computer system 600 may include an input device 612 configured to allow a user to interact with any of the components of system 600. The present invention contemplates a computer-readable medium 622 that includes instructions 624 or receives and executes instructions 624 responsive to a propagated signal so that a device connected to a network 626 can communicate voice, video, audio, images or any other data over the network 626. Further, the instructions 624 may be transmitted or received over the network 626 via a communication port or interface 620 or using the bus 608. The communication port or interface 620 may be a part of the processor 602 or may be a separate component. The communication port 620 may be created in software or may be a physical connection in hardware. The communication port 620 may be configured to connect with a network 626, external media, the display 610, or any other components in the computer system 600, or combinations thereof. The connection with the network 626 may be established wirelessly as discussed later. Likewise, the additional connections with other components of the computer system 600 may be established wirelessly. The network 626 may alternatively be directly connected to the bus 608.

The network 626 may include wireless networks that may be a cellular telephone network, an 802.11, 802.16, 802.20, 802.1Q or WiMax network. Further, the network 626 may be a public network, such as the Internet, a private network, such as an intranet, or combinations thereof, and may utilize a variety of networking protocols now available or later developed including, but not limited to TCP/IP based networking protocols. The system is not limited to operation with any particular standards and protocols. For example, standards for Internet and other packet switched network transmission (e.g., TCP/IP, UDP/IP, HTML, HTTP) may be used.

According to the aspects of the present subject matter, the DMS 100 is able to manage different types and frequencies of debt at a consumer level due to standardized debt representation, which currently no existing solution does. Furthermore, after personalized budgeting, the DMS 100 implements novel run-rate based mechanism to smooth out collections from funds account of the user. Furthermore, the DMS 100 modulates debt payments according to budgeting and is tailored towards goal, which is a new way of targeted collection. This prevents financial load due to bigger collections while keeping target in mind. Furthermore, the DMS 100 takes care of not only default plans, but also ensures financial gains through maximum interest savings by paying extra money towards expensive debt, which currently no system does. It also gives a view of upcoming allocation to maintain transparency to consumer.

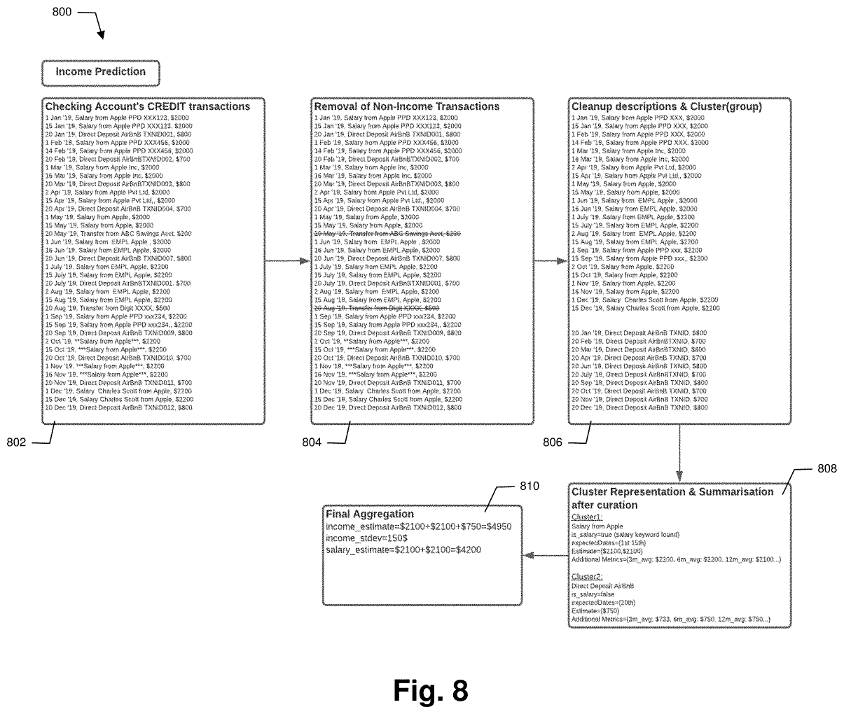

FIGS. 8-10 illustrate a use case example, in accordance with an example embodiment of the present subject matter. Referring to FIG. 8, a process 800 for income prediction is shown. In an example embodiment, the DMS 100 may be obtain at least one financial record. From the financial record, the DMS 100 may be configured to identify all the credit transactions, in operation 802. Thereafter, in operation 804, non-income transactions are identified and removed. As described herein, these transactions may be credits between own account, for example, bank accounts or digital wallets, of the user. Once the non-income transactions are removed, the DMS 100 then performs cleansing operation and groups the transactions, in operation 806.

In operation 808, the DMS 100 may be configured to represent the income sources in clusters and may summarize the income from each of the sources. Also, other metrics, for example, 3 month average, 6 month average, 12 month average income collected from the source may also be determined. In operation 810, the DMS 100 makes the final aggregation, the income from different sources is predicted.

In an example implementation, the DMS 100 computes or predicts the expenses in a similar manner as explained above herein. That is, the financial records corresponding to the funds account is obtained and accordingly the debits are identified to determine the expenses, as described herein. Once the income and expenses are predicted, the spare amount and collection amount may be determined accordingly.

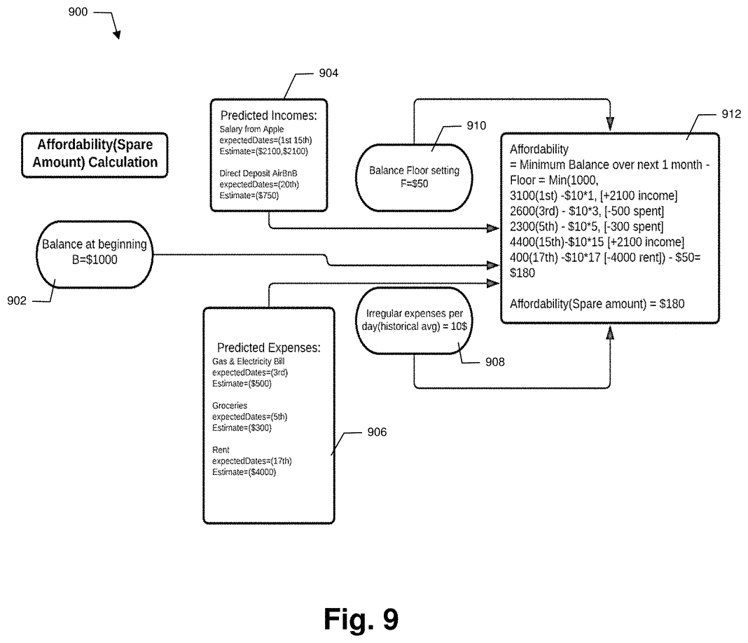

Referring to FIG. 9, a process 900 for spare amount calculation is shown. In an example embodiment, in operation 902, the DMS 100 may find out the balance “B”, which is available in at least one fund account of the user. In operations 904 and 906, the DMS 100 obtains the predicted incomes and predicted expenses, respectively. In operation 908, the DMS 100 checks for the irregular expenses, if any. Furthermore, as described herein, the DMS 100 also checks for any threshold for funds account, in operation 910. As shown, the threshold may be depicted as balance floor setting. On obtaining the aforementioned, the DMS 100 may be configured to determine the spare amount in operation 912. As is shown, the spare amount in the current use case is USD 180.

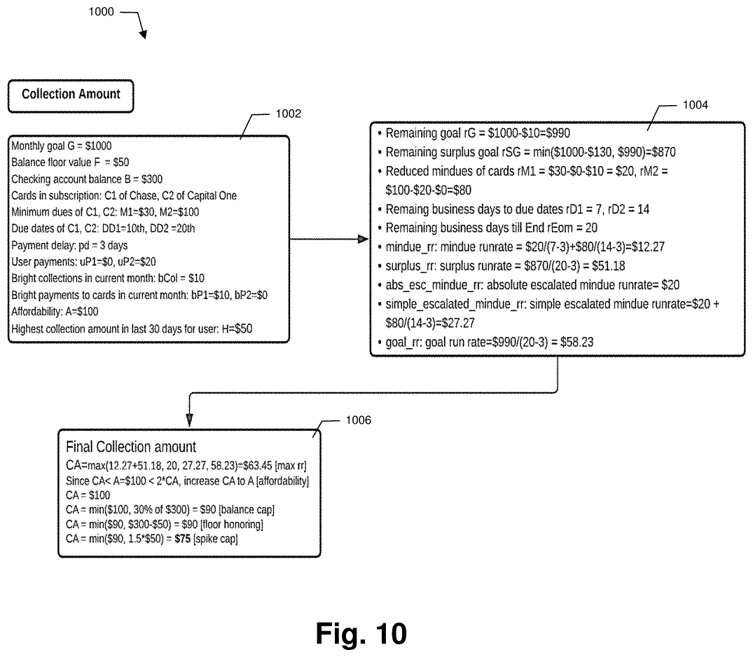

Referring to FIG. 10, a process 1000 for per day collection amount is shown. In an example embodiment, in operation 1002, the DMS 100 may be configured to check for the monthly goal, the balance floor value, the account balance, the cards and their minimum dues and respective dates. Furthermore, the DMS 100 may check for payment delays, any payments which the user may have done, the amount collected in collection fund account, represented by “bright” in the figure. Furthermore, payments made from collection fund account to the cards and highest income collected so far in the last 30 days is also checked.

Once the aforementioned is available, in operation 1004, the DMS 100 may be configured to check for the remaining goal, remaining surplus goals, remaining minimum dues, the no. of days to due dates, and remaining days from end. Furthermore, the DMS 100 checks for other factors as well which are described herein and in the figure. For instance, the minimum due run rate and surplus run rate may also be calculated, along with other shown values.

Accordingly, in operation 1006, the DMS 100 may compute the collection amount using the formula described herein. As is shown, a collection amount of USD 75 is determined for collection.

While specific language has been used to describe the present disclosure, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

1. A debt management system (DMS) for managing debt repayments corresponding to debt accounts associated with a user, the DMS comprising:
a memory comprising executable instructions;
a processor coupled to the memory and configured to execute the instructions;
an account management engine coupled to the processor, wherein the account management engine is configured to:
couple with one or more funds accounts associated with the user, wherein the coupling at least includes establishing of a communication session between the DMS and the one or more funds accounts;
obtain one or more financial records corresponding to the one or more funds accounts of the user, each financial record including at least historical transaction data of historic transactions performed using the corresponding funds account wherein to obtain the one or more financial records, the account management engine is configured to:
make a request to a bank aggregator for the one or more financial records; and
receive, in response to the request, the one or more financial records as aggregator data from a server of the bank aggregator;
couple with one or more debt accounts of the user; and
obtain one or more repayment records corresponding to the one or more debt accounts of the user, each repayment record including details associated with repayment of debt related to the corresponding debt account;
a debt management engine coupled to the processor, wherein the debt management engine is configured to:
predict income in the one or more funds accounts associated with the user for a predetermined period, based on the one or more financial records corresponding to the one or more funds account;
predict expenses to be incurred to the one or more funds accounts for the predetermined period, based on the one or more financial records corresponding to the one or more funds account;
determine a per-day spare amount for each day of the predetermined period, based on the predicted income and the predicted expenses; and
calculate a per-day collection amount to be collected from the one or more funds accounts for each day of the predetermined period, based at least on the one or more repayment records and the determined per-day spare amount for each day; and
a payments engine coupled to the processor, wherein the payments engine is configured to:
collect the calculated per-day collection amount from the one or more funds accounts associated with the user on each of the corresponding day of the predetermined period;
transfer the collected per-day collection amount on each of the corresponding day of the predetermined period to a collection fund account; and
make a payment in respect of at least one debt account of the one or more debt accounts, from the collection fund account.

2. The DMS of claim 1, wherein:
the account management engine is further configured to:
provide the user with an option to set a fund threshold corresponding to each of the one or more funds accounts associated with the user;
receive a user selection for setting the fund threshold of at least one funds account from the one or more funds account; and
wherein the payments engine is further configured to collect the calculated per-day collection amount from the one or more funds accounts, based on the fund threshold corresponding to the one or more funds accounts.

3. The DMS of claim 1, wherein the account management engine is further configured to:
identify, for each of the one or more debt accounts, the details associated with repayment of the debt from the corresponding repayment record;
generate a unified repayment record for the debt based on the identified details, wherein the unified repayment record includes the identified details in a default representation format; and
store the unified repayment record for the debt in a storage coupled to the DMS.

4. The DMS of claim 1, wherein the account management engine is further configured to:
detect a missing detail in the corresponding repayment record of the debt; and
infer an input corresponding to the missing detail based on one or more of: the one or more financial records and the one or more repayment records; and
include the inferred input corresponding to the missing detail in the unified payment record for the debt.

5. The DMS of claim 1, wherein:
the account management engine is configured to detect a non-predicted transaction in at least one funds account of the one or more funds account; and
the debt management engine is configured to:
update the predicted expenses;
update the determined per-day spare amount; and
update the calculated per-day collection amount.

6. The DMS of claim 1, wherein the calculated per-day collection amount for each day is equal to one of: at least a portion of the corresponding per-day spare amount for the day and the corresponding per-day spare amount for the day.

7. The DMS of claim 1, wherein the debt management engine is configured to:
obtain the repayment record corresponding to each of the one or more debt accounts of the user;
identify at least one debt account from the one or more debt accounts having a monetary-benefit policy associated therewith, based on the corresponding repayment record; and
predict the per-day collection amount of at least one day in the predetermined period based on the monetary-benefit policy.

8. The DMS of claim 1, wherein the debt management engine is configured to:
display the calculated per-day collection amount for each day of the predetermined period to the user using a display interface;
receive a user input for updating the calculated per-day collection amount for at least one day in the predetermined period, the user input defining a new collection amount; and
update the per-day collection amount for the one day based on the received user input.

9. The DMS of claim 1, wherein:
the payments engine is further configured to:
receive a user request to transfer a portion of the collection amount present in the collection fund account to at least one funds account from the one or more funds account of the user; and
transfer the portion of the collection amount to the at least one funds account; and
the debt management engine is configured to:
update the predicted income;
update the determined per-day spare amount; and
update the calculated per-day collection amount.

10. A method of managing debt repayments corresponding to debt accounts associated with a user, the method comprising:
coupling with one or more funds accounts associated with the user, wherein the coupling at least includes establishing of a communication session between a debt management system (DMS) and the one or more funds accounts;
obtaining one or more financial records corresponding to the one or more funds accounts of the user, each financial record including at least historical transaction data of historical transactions performed using the corresponding funds account, wherein the obtaining comprises:
making a request, by an account management engine, to a bank aggregator for the one or more financial records; and
receiving, in response to the request, the one or more financial records as aggregator data from a server of the bank aggregator;
coupling with one or more debt accounts of the user;
obtaining one or more repayment record corresponding to the one or more debt accounts of the user, each repayment record including details associated with repayment of debt related to the corresponding debt account;
predicting income in the one or more funds accounts associated with the user for a predetermined period, based on the one or more financial records corresponding to the one or more funds account;
predicting expenses to be incurred to the one or more funds accounts for the predetermined period, based on the one or more financial records corresponding to the one or more funds account;
determining a per-day spare amount for each day of the predetermined period, based on the predicted income and the predicted expenses;
calculating a per-day collection amount to be collected from the one or more funds account for each day of the predetermined period, based at least on the one or more repayment records and the determined per-day spare amount for each day;
collecting the calculated per-day collection amount from the one or more funds accounts associated with the user on each of the corresponding day of the predetermined period;
transferring the collected per-day collection amount on each of the corresponding day of the predetermined period to a collection fund account; and
making a payment in respect of at least one debt account from the one or more debt accounts, from the collection fund account.

11. The method of claim 10, wherein the method further comprises:
providing the user with an option to set a fund threshold corresponding to each of the one or more funds accounts associated with the user;
receiving a user selection for setting the fund threshold of at least one funds account from the one or more funds account; and
collecting the calculated per-day collection amount from the one or more funds accounts, based on the fund threshold corresponding to the one or more funds accounts.

12. The method of claim 10, wherein the method further comprises:
identifying, for each of the one or more debt accounts, the details associated with repayment of the debt from the corresponding repayment record;
generating a unified repayment record for the debt based on the identified details, wherein the unified repayment record includes the identified details in a default representation format; and
storing the unified repayment record for the debt in a storage.

13. The method of claim 10, wherein the method further comprises:
detecting a missing detail in the corresponding repayment record of the debt;
inferring an input corresponding to the missing detail based on one or more of: the one or more financial records and the one or more repayment records; and
including the inferred input corresponding to the missing detail in the unified payment record for the debt.

14. The method of claim 10, wherein the method further comprises:
detecting a non-predicted transaction in at least one funds account of the one or more funds account;
updating the predicted expenses;
updating the determined per-day spare amount; and
updating the calculated per-day collection amount.

15. The method of claim 10, wherein the calculated per-day collection amount for each day is equal to one of: at least a portion of the corresponding per-day spare amount for the day and the corresponding per-day spare amount for the day.

16. The method of claim 10, wherein the method further comprises:
obtaining the repayment record corresponding to each of the one or more debt accounts of the user;
identifying at least one debt account from the one or more debt accounts having a monetary-benefit policy associated therewith, based on the corresponding repayment record; and
predicting the per-day collection amount of at least one day in the predetermined period based on the monetary-benefit policy.

17. The method of claim 10, wherein the method further comprises:
displaying the calculated per-day collection amount for each day of the predetermined period to the user using a display interface;
receiving a user input for updating the calculated per-day collection amount for at least one day in the predetermined period, the user input defining a new collection amount; and
updating the per-day collection amount for the one day based on the received user input.

18. The method of claim 10, wherein the method further comprises:
receiving a user request to transfer a portion of the collection amount present in the collection fund account to at least one funds account from the one or more funds account of the user;
transferring the portion of the collection amount to the at least one funds account;
updating the predicted income;
updating the determined per-day spare amount; and
updating the calculated per-day collection amount.

19. A non-transitory computer-readable medium comprising computer code for managing debt repayments corresponding to debt accounts associated with a user, wherein the computer code of the computer-readable medium is executable by a processor to perform the following:
coupling with one or more funds accounts associated with the user, wherein the coupling at least includes establishing of a communication session between a debt management system (DMS) and the one or more funds accounts;
obtaining one or more financial records corresponding to the one or more funds accounts of the user, each financial record including at least historical transaction data of historical transactions performed using the corresponding funds account, wherein the obtaining comprises:
making a request, by an account management engine, to a bank aggregator for the one or more financial records; and
receiving, in response to the request, the one or more financial records as aggregator data from a server of the bank aggregator;
coupling with one or more debt accounts of the user;
obtaining one or more repayment record corresponding to the one or more debt accounts of the user, each repayment record including details associated with repayment of debt related to the corresponding debt account;
predicting income in the one or more funds accounts associated with the user for a predetermined period, based on the one or more financial records corresponding to the one or more funds account;
predicting expenses to be incurred to the one or more funds accounts for the predetermined period, based on the one or more financial records corresponding to the one or more funds account;
determining a per-day spare amount for each day of the predetermined period, based on the predicted income and the predicted expenses;
calculating a per-day collection amount to be collected from the one or more funds account for each day of the predetermined period, based at least on the one or more repayment records and the determined per-day spare amount for each day;
collecting the calculated per-day collection amount from the one or more funds accounts associated with the user on each of the corresponding day of the predetermined period;
transferring the collected per-day collection amount on each of the corresponding day of the predetermined period to a collection fund account; and
making a payment in respect of at least one debt account from the one or more debt accounts, from the collection fund account

20. The non-transitory computer-readable medium as recited in claim 19, wherein the computer code is further executable by the processor to perform the following:
providing the user with an option to set a fund threshold corresponding to each of the one or more funds accounts associated with the user;
receiving a user selection for setting the fund threshold of at least one funds account from the one or more funds account; and
collecting the calculated per-day collection amount from the one or more funds accounts, based on the fund threshold corresponding to the one or more funds accounts.
